(19) United States
(12) Patent Application Publication
(10) Pub. No.: US 2008/0260395 A1
(43) Pub. Date: Oct. 23, 2008

(54) IMAGE FORMING APPARATUS AND MISPRINT DETECTION METHOD

(75) Inventor: Mikimasa HONMA, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/016,389

(22) Filed: Jan. 18, 2008

(30) Foreign Application Priority Data
Mar. 30, 2007 (JP) JP2007-092822

(51) Int. Cl. G03G 15/00

(52) U.S. Cl. 399/15

(57) ABSTRACT

An image forming apparatus includes: an image forming unit for forming an image based on an input image data on a recording medium on which a first image is previously formed; a storage unit for storing an image data relating to the first image; a first reading unit for reading a second image on the recording medium after the image is formed on the recording medium by the image forming unit; and a control unit for comparing an image data obtained by superposing the input image data on the image data relating to the first image with an image data relating the second image read by the first reading unit to detect a misprint in the image forming unit.

### BACKGROUND OF THE INVENTION

1. Field of the Invention

The present invention relates to an image forming apparatus and a misprint detection method.

2. Description of the Related Art

Conventionally, in an image forming apparatus for forming an image on a recording medium such as paper (“sheet” hereinafter) based on input image data, such as image data read by a scanner or the like or image data transmitted from an external device, image data read from a sheet after image forming is compared with image data which is an original for the image forming on the sheet to detect a misprint, and the misprint is separated from a sheet on which an image is normally formed and the misprint is ejected.

For example, in an image forming apparatus which transfers a toner image to a sheet based on image information to form an image, Japanese Patent Application Laid-Open No. 8-115016 discloses a technology of reading the image formed on the sheet after the transfer, comparing the read image with the image information, and branching a conveying destination of the sheet so that the sheet can pass through a toner removal apparatus when it is determined that both images are different from each other, to erase the image without destroying the sheet when the image on the sheet is defective.

Japanese Patent Application Laid-Open No. 2000-10443 discloses a technology of reading an image formed on a sheet, comparing the read image with image data read from an image memory by pattern matching to detect coincidence/noncoincidence between both pieces of information, and then separating and ejecting a relevant sheet when noncoincidence is detected.

Japanese Patent Application Laid-Open No. 2004-56483 discloses a technology of preventing a normal sheet originally having no image disturbance from being recognized to be defective, by selecting one of a first mode for reading and storing an image of a sheet on which the image is formed and a second mode for comparing a read image with the stored image to determine whether the images are similar.

However, in the aforementioned conventional technologies, an image has already been formed on the sheet. Thus, when additional printing is carried out for the sheet, there is some possibility that it is determined that the formed image is defective, and it is not possible to accurately detect a defective image during additional printing. For example, in the case of additionally printing in which an address or the like is printed on a postcard in which a stamp of charges to be paid later or a fill-in space for a zip code have been printed, even if there is no disturbance of the additionally printed image, there is some possibility that the stamp of charges to be paid later or the fill-in space for the zip code are detected as defective images. As a result, it is not possible to accurately detect a misprint.

### SUMMARY OF THE INVENTION

An object of the present invention is to accurately detect a misprint even during additional printing.

To achieve at least one of the aforementioned objects, according to an embodiment reflecting one aspect of the present invention, an image forming apparatus comprises: an image forming unit for forming an image based on an input image data on a recording medium on which a first image is previously formed; a storage unit for storing an image data relating to the first image; a first reading unit for reading a second image on the recording medium after the image is formed on the recording medium by the image forming unit; and a control unit for comparing an image data obtained by superposing the input image data on the image data relating to the first image with an image data relating the second image read by the first reading unit to detect a misprint in the image forming unit.

Preferably, the image forming apparatus further comprises a second reading unit for reading the first image which is previously formed on the recording medium, wherein the storage unit stores image data read by the second reading unit.

In the image forming apparatus, preferably, the second reading unit reads the first image in a conveying path from a paper feeding unit for storing the recording medium on which the first image is formed, to the image forming unit.

In the image forming apparatus, preferably, the second reading unit reads the first image in a paper feeing unit for storing the recording medium on which the first image is formed.

Preferably, the image forming apparatus further comprises a document image reading unit for reading a document image, wherein the storage unit stores image data obtained by reading the first image of the recording medium by the document image reading unit.

Preferably, the image forming apparatus further comprises a plurality of ejecting units for ejecting the recording medium on which the image is formed by the image forming unit, wherein the control unit ejects the recording medium to an ejecting unit which is previously set as an ejection destination of the misprint among the plurality of ejecting units when the misprint is detected.

Preferably, the image forming apparatus further comprises an operation display unit, wherein the control unit displays a warning on the operation display unit when the misprint is detected.

Preferably, the image forming apparatus further comprises an ejecting unit for ejecting the recording medium on which the image is formed by the image forming unit based on the input image data, wherein the first reading unit reads the second image of the recording medium in a conveying path from the image forming unit to the ejecting unit.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a conceptual diagram illustrating a configuration of an image forming apparatus;

FIG. 2 is a block diagram schematically illustrating a functional configuration of the image forming apparatus;

FIG. 3 is a flowchart illustrating an operation of the image forming apparatus;

FIG. 4 is a flowchart illustrating a reading process of the image forming apparatus; and

FIG. 5 is a conceptual diagram illustrating the superposing of an image which is previously formed on a sheet and an image to be formed on the sheet.

### DETAILED DESCRIPTION OF PREFERRED EMBODIMENT

The preferred embodiment of the present invention will be described with reference to the accompanying drawings. However, the invention is not limited to the embodiment. The embodiment of the invention is a most preferred mode, and a scope of the invention is not limited to this.

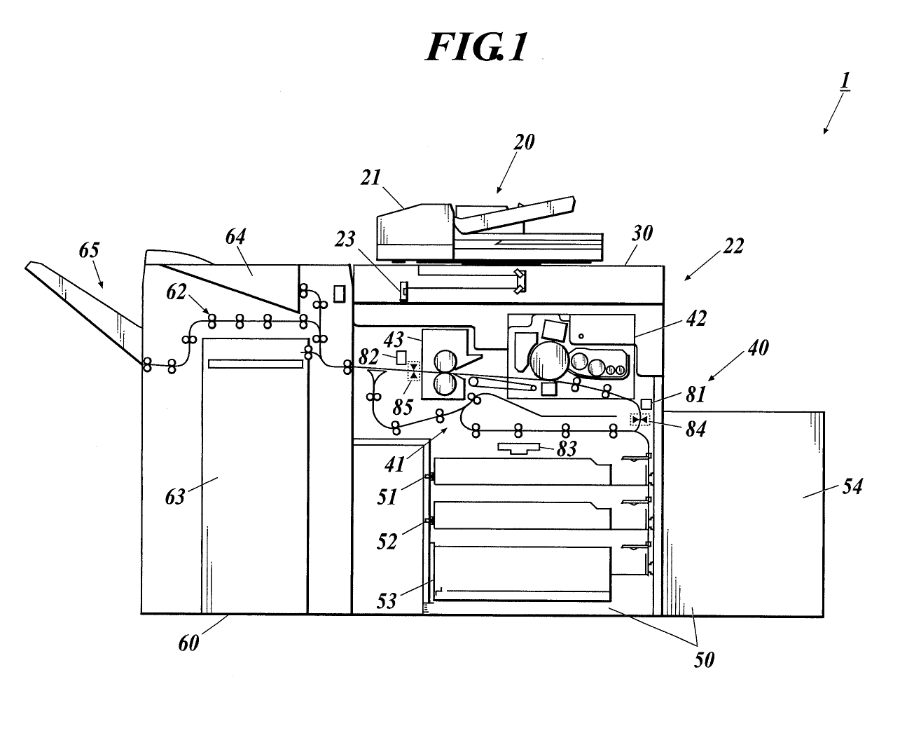

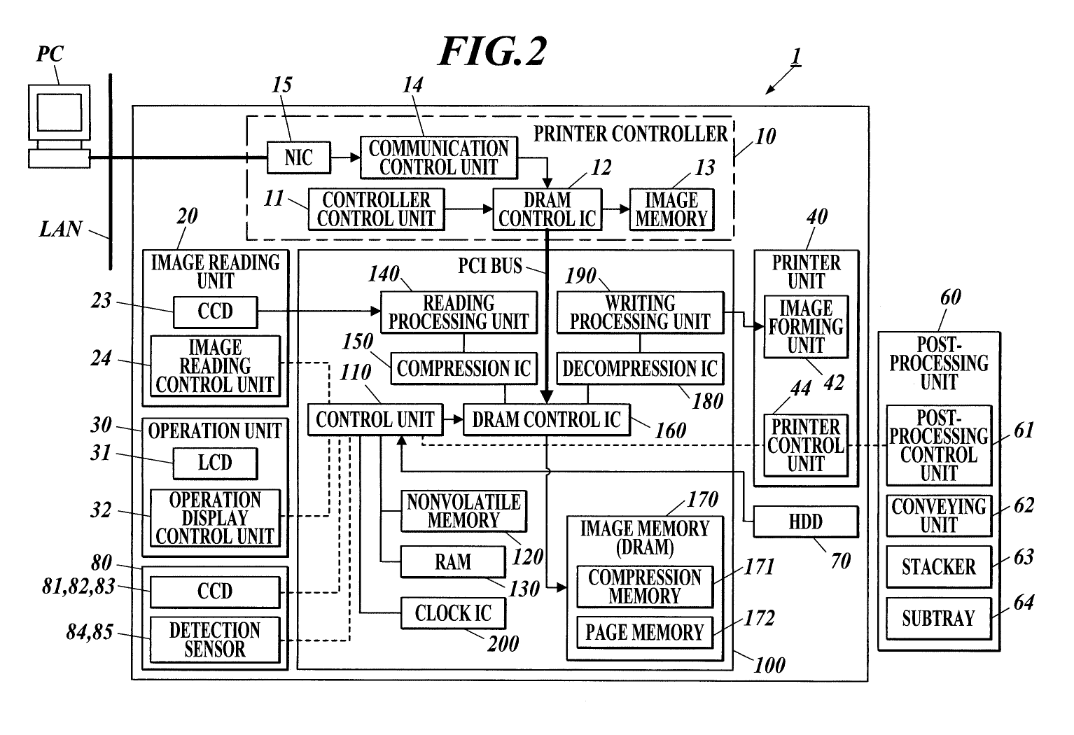

First, referring to FIGS. 1 and 2, an image forming apparatus illustrated in the embodiment will be described. FIG. 1 illustrates a configuration of an image forming apparatus 1. FIG. 2 schematically illustrates a functional configuration of the image forming apparatus 1.

As illustrated in FIG. 1, the image forming apparatus 1 includes an image reading unit 20, an operation display unit 30, a printer unit 40, a paper feeding unit 50, and a post-processing unit 60.

The image reading unit 20 includes an auto document feeder (ADF) 21, and a scanner 22. The ADF 21 conveys a document set on a document base. The scanner 22 optically scans the document conveyed by the ADF 21 via a contact glass, or a document set on a platen glass, and photoelectrically converts the document by a charge-coupled device (CCD) image sensor 23 to read an image of the document. As a result, the image data is obtained.

Various image processes are carried out for the image data read by the image reading unit 20 by a control unit 110 described below, and the image data is outputted as image data for forming an image to the printer unit 40.

The operation display unit 30 includes various function keys such as a numeral button, a start key for instructing an image forming start, and a utility key, receives user's input, and outputs the input information to the control unit 110. The operation display unit 30 includes a liquid crystal display (LCD) 31. A touch panel for receiving touch inputs on a screen is disposed in the LCD 31 to display various operation screens such as a setting screen of setting conditions or various processing results.

The printer unit 40 carries out the image forming by the electrophotography, and includes a conveying mechanism 41 for conveying a sheet fed from the paper feeding unit 50, an image forming unit 42 for forming an image on a sheet, and a fixing unit 43 for fixing a toner image formed on a sheet.

The image forming unit 42 includes a photoconductor drum which is an image carrier, a charging unit for charging the photoconductor drum, an exposing unit such as a laser diode (LD) for exposing and scanning a photoconductor drum surface base on image data, a developing unit for developing an electrostatic latent image on the photoconductor drum, a transferring unit for transferring a toner image formed on the photoconductor drum to a sheet, and a cleaning unit for removing residual toner on the photoconductor drum.

According to the embodiment, the printer unit 40 performs the image forming by the electrophotography. However, the invention is not limited to this method. Other image forming methods such as an ink jet method, a thermal transfer method, and a dot impact method or the like may be used.

The paper feeding unit 50 includes four paper feed trays 51 to 54. According to the embodiment, the four paper feed trays are provided. However, the invention is not limited to this. The number of trays is not limited. The paper feed trays 51 to 54 can accept various types of sheets, such as plain paper, backing paper, recycled paper and bond paper, and sheets having different sizes.

The post-processing unit 60 includes various post-processing units (not shown) for performing various post-processes such as sorting, punching (boring), stapling, folding, and cutting in a sheet where an image has been formed by the printer unit 40, under control of a post-processing control unit described below, and a conveying path 62 for conveying the post-processed sheet to an output destination.

The post-processing unit 60 includes a stacker 63 as an ejection destination of the conveying unit 62 to stack about 5000 sheets, and take out the stacked sheets by an opening/closing door, a subtray 64 as an ejecting tray to easily check ejected sheets from the outside, and a main tray 65 as an ejecting tray to change ejecting positions of sheets for each document, stack, sort and output the sheets under control of the post-processing control unit.

The CCDs 81 to 83 and the detection sensors 84 and 85 are installed as sheet image reading units in the paper feeding unit 50, a conveying path from the paper feeding unit 50 to the image forming unit 42, and a conveying path for conveying a sheet on an image is formed by the image forming unit 42 to the post-processing unit 60.

The CCD's 81 and 82 are installed for picking up an image in a conveying path direction, and read images on sheets conveyed on the conveying path. The CCD 83 is installed in the paper feed tray to pick up an image on a sheet set therein, and reads an image of the sheet. In the shown example, the CCD 83 is installed in the paper feed tray 51, and picks up an image on a sheet set in the paper feed tray 51. However, CCD may be installed in each of the other paper feed trays.

The detection sensors 84 and 85 are optical sensors for receiving lights reflected on sheets conveyed through the conveying paths among lights with which the conveying paths are irradiated, and to change output state of sensor signals based on light amount changes of the received lights. In other words, in the image forming apparatus 1, it is possible to detect leading and tail ends of sheets based on output signals from the detection sensors 84 and 85 when the sheets conveyed along the conveying paths pass through the detection sensors 84 and 85.

The CCD 81 and the detection sensor 84 are arranged on the conveying path of a sheet from the paper feeding unit 50 to the image forming unit 42, and detect leading and tail ends of a sheet conveyed to the image forming unit 42 to enable reading of an image on a sheet before an image is formed therein. More preferably, the CCD 81 and the detection sensor 84 are arranged on the conveying path at the position immediately before the sheet is conveyed to the image forming unit 42 to enable reading not only an image of the sheet conveyed from the paper feeding unit 50 but also an image of the sheet inverted for backside printing.

The CCD 83 picks up an image on a sheet set in the paper feeding unit 50 to enable reading of an image of a sheet before an image is formed therein. The CCD 82 and the detection sensor 85 are arranged on a conveying path for conveying a sheet on which an image is formed by the image forming apparatus 42 to the post-processing unit 60, and detect leading and tail ends of the sheet conveyed to the post-processing unit 60 to enable reading of an image of the sheet on which the image is formed.

A functional configuration of the image forming apparatus 1 will be described. As illustrated in FIG. 2, the image forming apparatus 1 includes a control board 100, a printer controller 10, an image reading unit 20, an operation display unit 30, a printer unit 40, a post-processing unit 60, a hard disk drive (HDD) 70, and a sheet image reading unit 80.

The printer controller 10 includes a controller control unit 11, a DRAM control integrated circuit (IC) 12, an image memory 13, a communication control unit 14, a network interface card (NIC) 15.

The controller control unit 11 realizes a function of comprehensively controlling operations of the units, and distributing output data such as image data output from a user terminal personal computer (PC) of a local area network (LAN) via the communication control unit 14 and the NIC 15 as a job to the DRAM control IC 160.

The DRAM control IC 12 controls storing of output data received by NIC 15 and the communication control unit 14 in the image memory 13, and reading of output data from the image memory 13. The DRAM control IC 12 is connected to the DRAM control IC 160 through a peripheral components interconnect (PCI) bus, and reads output data to be printed from the image memory 13 to output it to the DRAM control IC 160 according to an instruction from the controller control unit 11.

The image memory 13 includes a dynamic random access memory (DRAM), and temporarily stores input output data.

The communication control unit 14 controls communication of the NIC 15. The NIC 15 is a communication interface for connecting to the LAN, and receives output data to be printed from a user terminal PC via the LAN. The received output data is output to the DRAM control IC 12.

The image reading unit 20 includes the ADF unit 21 illustrated in FIG. 1, a scanner unit 22 having a CCD image sensor 23, and an image reading control unit 24. The image reading control unit 24 controls the ADF unit 21 and the scanner unit 22 to execute light scanning of a document surface, and to read a read analog image signal to output the read signal to a reading processing unit 140 according to an instruction from the control unit 110.

The operation display unit 30 includes a touch panel integrally provided with the LCD 31 as a display unit, various function keys (not shown), and an operation display control unit 32. The operation display control unit 32 outputs operation signals operated by various function keys or the touch panel to the control unit 110. The operation display control unit 32 displays various operation screens, various processing results or the like in the LCD 31 according to an instruction from the control unit 110.

The printer unit 40 includes units such as the image forming unit 42 relating to the image forming, and a printer control unit 44. The printer control unit 44 controls an operation of each unit of the printer unit 40 to form an image by the image forming unit 42 and the like based on image data input from a writing processing unit 190 according to an instruction from the control unit 110.

The post-processing unit 60 includes various post-processing units (not shown), a post-processing control unit 61, a conveying unit 62, a stacker 63, and a subtray 64. The post-processing control unit 61 controls various post-processing units to perform various post-processes for a sheet on which an image is formed and which is output from the printer unit 40, according to an instruction from the control unit 110. The post-processing control unit 61 controls the conveying unit 62 to change an output destination of a post-processed sheet to the stacker 63 or the subtray 64 according to an instruction from the control unit 110.

The HDD 70 stores information so as to allow reading/writing of the information. The HDD 70 stores compressed image data compressed by a compression IC 150 described below.

The sheet image reading unit 80 includes the CCDs 81 to 83 and the detection sensors 84 and 85, reads an image of a sheet before the image forming or an image of a sheet after the image forming, and outputs the read image data to the control unit 110.

The control board 100 includes a control unit 110, a nonvolatile memory 120, a random access memory (RAM) 130, a reading processing unit 140, a compression IC 150, a DRAM control unit IC 160, an image memory 170, a decompression IC 180, a writing processing unit 190, and a clock IC 200.

The control unit 110 includes a central processing unit (CPU) and the like to control the units of the image forming apparatus 1 in a concentrated manner. The control unit 110 reads a designated program or data from a system program, various application programs, or setting information stored in the nonvolatile memory 120 to expand the data in the RAM 130, and executes various processes cooperatively with the program expanded in the RAM 130.

Specifically, the control unit 110 executes processing described below to control each unit, and performs the image forming based on input image data such as image data output by reading a document at the image reading unit 20 or image data transmitted from an external device such as a user terminal PC via the NIC 15.

The control unit 110 controls the HDD 70 to store the compressed image data compressed by the compression IC 150 or the compressed image data stored in the image memory 170.

The nonvolatile memory 120 includes a flash memory to store various programs or data so as to be rewritable. For example, the nonvolatile memory 120 stores a counter for counting the number of sheets on which images are formed. The nonvolatile memory 120 stores data such as a compression rate of compressed image data compressed by the compression IC 150 described below to be stored in the compression memory 171 or a threshold value for determining a data size of compressed image data.

The reading processing unit 140 carries out various processes such as analog processing, A/D conversion processing, and shading processing for an analog image signal input from the image reading control unit 24 of the image reading unit 20 to generate digital image data. The generated digital image data is output to the compression IC 150.

The compression IC 150 carries out a compression processing for digital image data input from the reading processing unit 140 or the printer controller 10 by using a well-known encoding technology to output the data to the DRAM control unit 160.

A specific example of the compression process at the compression IC 150 is a joint photographic experts group (JPEG) conversion process in which an image is divided into blocks of a fixed size (8×8 pixels), the discrete cosine transform (DCT) is carried out for the divided image by block units, and the entropy encoding is carried out by Huffman coding after the converted data are quantized, to compress the converted data. Although other compression processes are not described here, the compression process at the compression IC 150 may be other than the JPEG conversion process.

According to an instruction from the control unit 110, the DRAM control IC 160 controls the compression processing of digital image data, which is performed by the compression IC 150 and the decompression processing of the compressed image data, which is performed by the decompression IC 180 and input/output of image data to the image memory 170. For example, when the saving of an analog image signal read by the image reading unit 20 is instructed, the compression processing of digital image data input from the reading processing unit 140 is executed by the compression IC 150, and the compressed image data is stored in the compression memory 171 of the image memory 170.

When the DRAM control IC 160 is instructed to print out the compressed image data stored in the compression memory 171, the DRAM control IC 160 reads the compressed image data from the compression memory 171, and carries out the decompression processing for the data by the decompression IC 180 to store the decompressed image data in the page memory 172. When the DRAM control unit IC 160 is instructed to print out uncompressed image data stored in the page memory 172, the DRAM control unit IC 160 reads the uncompressed image data from the page memory 172 to output the uncompressed image data to the writing processing unit 190.

The image memory 170 includes a compression memory 171 such as a DRAM, and a page memory 172. The compression memory 171 is a memory for storing compressed image data. The page memory 172 is a memory for temporarily storing uncompressed image data to be printed out before the printing out.

The decompression IC 180 carries out the decompression processing for input compressed image data. The writing processing unit 190 generates print data for forming an image based on uncompressed image data input from the DRAM control IC 160 to output the print data to the printer unit 40 (image forming unit 42).

The clock IC 200 counts date and time information such as a date or time, and obtains date and time information at the time of the request from the control unit 110 to output the information to the control unit 110.

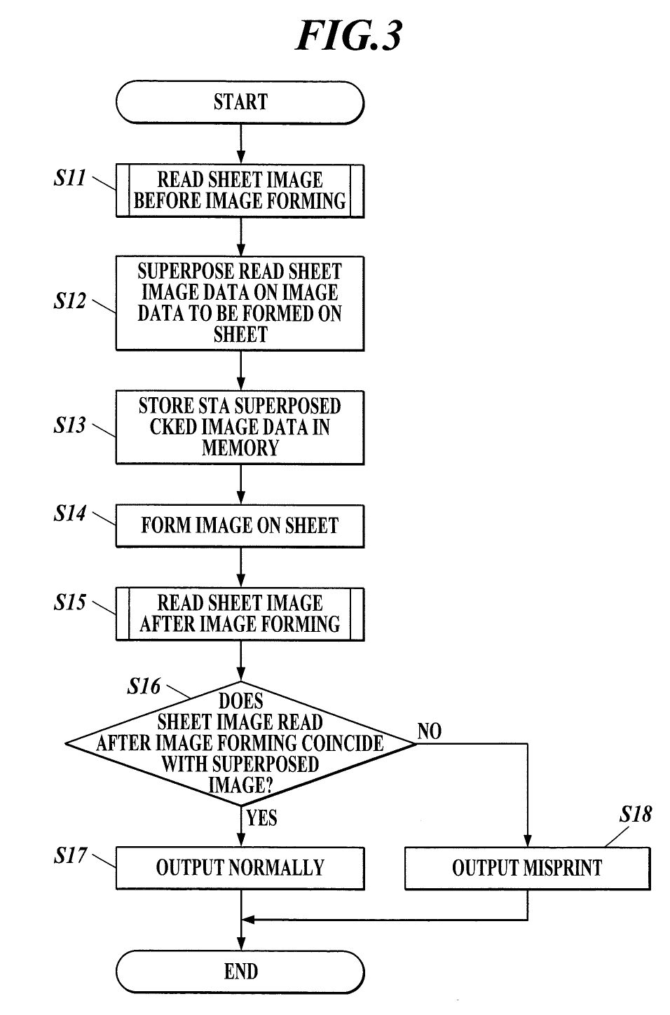

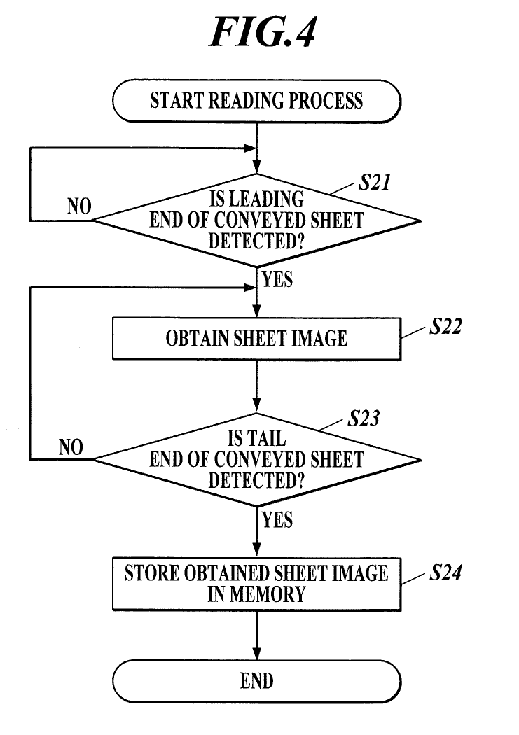

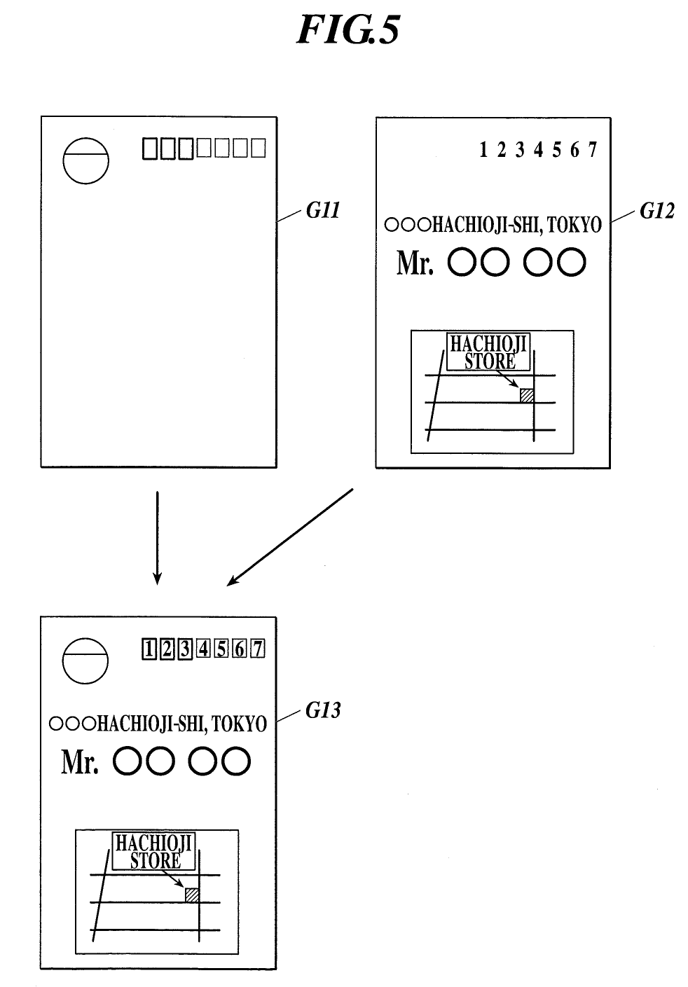

Referring to FIGS. 3 to 5, an operation of the image forming apparatus 1, which is controlled by the control unit 110 will be described. FIG. 3 illustrates the operation of the image forming apparatus 1, which is executed by the control unit 110. FIG. 4 illustrates a reading process of the image forming apparatus 1, which the control unit 110 performs by controlling the sheet image reading unit 80. FIG. 5 illustrates an image G13 obtained by superposing images G11 and G12.

As illustrated in FIG. 3, when the starting of the image forming based on input image data such as image data read by the image reading unit 20 or image data input via the NIC 15 is instructed from the operation display unit 30 or the user terminal PC, a sheet set in the paper feeding unit 50 is conveyed to read a sheet image before the image forming based on outputs from the CCD 81 and the detection sensor 84 (step S1).

The reading process (step S1) will be described below in detail.

As illustrated in FIG. 4, when the reading process is started, the process stands by until a leading end of a conveyed sheet is detected based on an output from the detection sensor 84 (step S21).

In step S21, when the leading end of the sheet is detected (YES), until a tail end of the conveyed sheet is detected based on the output from the detection sensor 84, image data output from the CCD 81 is obtained, and the sheet image is obtained based on the image data (steps S22 and S23).

Then, image data relating to the obtained sheet image is stored in a memory such as the RAM 130 or the image memory 170 (step S24) to finish the reading process.

In the aforementioned reading process relating to the sheet image before the image forming, a processing configuration in which the image is read when the sheet is conveyed from the paper feeding unit 50 to the image forming unit 42, is exemplified. However, the process may employ a processing configuration in which the image of the sheet set in the paper feeding unit 50 is picked up by the CCD 83 before the conveying, and the picked-up image data is stored in the memory. In an embodiment where an image of a sheet in the paper feeding unit 51 is picked up by the CCD 83 to read an image, the sheet fed from the paper feeding unit 51 is inverted from front to back by using a conveying path for surface printing, and then is conveyed to the image forming unit 42.

Before the sheet is set in the paper feeding unit 50, the sheet may be read by the image reading unit 20, and the sheet image before the image forming may be previously stored in the memory. In this case, the reading process in the step S11 can be omitted.

Referring back to FIG. 3, a process after the reading process (step S11) will be described.

After the reading process, the read sheet image data stored in the memory, i.e., image data relating to the sheet image before the image forming, and image data formed on the sheet by the image forming unit 42, i.e., input image data, are superposed by well-known image processing such as XOR calculation (step S12), and the superposed image data is stored in the memory (step S13).

The superposed image data stored in the memory in the step S13 is, specifically as illustrated in FIG. 5, image data relating to an image G13 obtained by superposing an image G11 of a stamp of charges to be paid later or a fill-in space for a zip code which are previously formed in a sheet such as a postcard, and an image G12 of a zip code, an address or an image formed in the postcard.

Then, an image is formed on the sheet by the image forming unit 42 based on the input image data (step S14). A reading process of the sheet image after the image forming is carried out based on outputs from the CCD 82 and the detection sensor 85 as described before similarly to the case of the step S11 (step S15).

Then, whether the sheet image data read after the image forming of the input image data and stored in the memory in the step S13, i.e., the image data relating to the sheet image after the image forming, coincides with the superposed image data stored in the memory in the step S13 is determined (step S16). The determination whether the image data relating to the sheet image after the image forming coincides with the superposed image data, is carried out based on a well-known pattern matching process, for example, in which the image data are compared with each other for each pixel data, and it is determined that the image data coincide with each other when the numbers of pixels equal to or more than a predetermined value coincide with each other.

In the case of the determination of a misprint, which is carried out by comparing the image data formed on the sheet with the sheet image after the image forming based on the image data, when additional printing is executed, there is some possibility that an image which is previously formed on the sheet is detected as a misprint and that the erroneous determination is caused. However, in the case of the determination of a misprint in the step S16, the image G13 shown in FIG. 5 is compared with the sheet image after the image forming. Thus, even when additional printing is carried out, the printing can be accurately executed without any erroneous determination caused by the image which is previously formed on the sheet.

When it is determined that two image data coincide with each other (YES) in the determination of the step S16, normal outputting in which the sheet on which the image is formed is conveyed and outputted to an ejection destination selected from the stacker 63, the subtray 64, and the main tray 65 based on an instruction from the operation display unit 30 or the user terminal PC is carried out (step S17) to finish the process.

When it is determined that two image data do not coincide with each other (NO) in the determination of the step S16, misprint outputting in which the sheet on which the image is formed is conveyed and outputted to an ejection destination set as an output destination of a misprint based on an instruction from the operation display unit 30 or the user terminal PC or based on the setting stored in a memory is carried out (step S18) to finish the process. During the misprint outputting, a warning screen showing the misprinting may be displayed in the LCD 31.

As described above, under the control of the control unit 110, the image forming apparatus 1 stores image data relating to an image (first image) which is previously formed on a sheet in the memory such as the RAM 130 or the image memory 170, and compares data obtained by superposing the image data on input image data for forming an image on the sheet by the image forming unit 42 with image data relating to an image (second image) formed on the sheet on which the image is formed, and read by the CCD 82 and the detection sensor 85 to detect a misprint in the image forming unit 42.

Accordingly, even when an image has been already formed on a sheet and additional printing is carried out for the sheet, the image forming apparatus 1 can accurately detect a misprint without any erroneous determination caused by the image which is previously formed on the sheet.

The image forming apparatus 1 includes the CCD 81, the detection sensor 84, and the CCD 83 for reading an image (first image) which is previously formed on a sheet, and can store read image data in the memory such as the RAM 130 or the image memory 170. Thus, time and labor for previously storing the image data relating to the first image in the memory can be omitted by the image reading unit 20 or the like.

The image forming apparatus 1 includes the CCD 81 and the detection sensor 84 on the conveying path for conveying the sheet from the paper feeding unit 50 for storing the sheet before an image is formed by the image forming unit 42 to the image forming unit 42. Thus, during the image forming at the image forming apparatus 42, the first image can be obtained when the sheet is conveyed from the paper feeding unit 50 to the image forming unit 42. The image forming apparatus 1 includes the CCD 83 for picking up an image on the sheet set in the paper feeding unit 50. Thus, during the image forming at the image forming unit 42, the first image can be obtained by picking up an image on the sheet stored in the paper feeding unit 50.

The description of the embodiment is only an example, and the present invention is not limited to this. The configuration and the operations of the embodiment can be suitably changed.

According to one aspect of the preferred embodiment of the present invention, the image data relating to the image obtained by superposing the image data relating to the first image which is previously formed on the recording medium and the input image data for forming an image on the recording medium is compared with the image data relating to the second image formed on the recording medium on which the image is formed and then the misprint in the image forming unit is detected. Thus, even when an image has been already formed on the recording medium, and the additional printing is carried out for the recording medium, a misprint can be accurately detected.

According to the aforementioned embodiment, the first image which is previously formed on the recording medium is read, and the image obtained by superposing the image data relating to the read first image on the input image data is compared with the second image formed on the recording medium on which the image is formed. Therefore, it is possible to detect a misprint in the image forming unit.

According to the aforementioned embodiment, the reading of the first image which is previously formed on the recording medium before an image is formed by the image forming unit can be carried out in the paper feeding unit for storing the recording medium, or in the conveying path from the paper feeding unit to the image forming unit.

The present U.S. patent application claims the priority of Japanese Patent Application No. 2007-92822 filed on Mar. 30, 2007, according to the Paris Convention, and the above Japanese Patent Application is the basis for correcting mistranslation of the present U.S. patent application.

What is claimed is:

1. An image forming apparatus comprising:
an image forming unit for forming an image based on an input image data on a recording medium on which a first image is previously formed;
a storage unit for storing an image data relating to the first image;
a first reading unit for reading a second image on the recording medium after the image is formed on the recording medium by the image forming unit; and
a control unit for comparing an image data obtained by superposing the input image data on the image data relating to the first image with an image data relating the second image read by the first reading unit to detect a misprint in the image forming unit.

2. The image forming apparatus of claim 1, further comprising a second reading unit for reading the first image which is previously formed on the recording medium,
wherein the storage unit stores image data read by the second reading unit.

3. The image forming apparatus of claim 2, wherein the second reading unit reads the first image in a conveying path from a paper feeding unit for storing the recording medium on which the first image is formed, to the image forming unit.

4. The image forming apparatus of claim 2, wherein the second reading unit reads the first image in a paper feeing unit for storing the recording medium on which the first image is formed.

5. The image forming apparatus of claim 1, further comprising a document image reading unit for reading a document image,
wherein the storage unit stores image data obtained by reading the first image of the recording medium by the document image reading unit.

6. The image forming apparatus of claim 1, further comprising a plurality of ejecting units for ejecting the recording medium on which the image is formed by the image forming unit,
wherein the control unit ejects the recording medium to an ejecting unit which is previously set as an ejection destination of the misprint among the plurality of ejecting units when the misprint is detected.

7. The image forming apparatus of claim 1, further comprising an operation display unit,
wherein the control unit displays a warning on the operation display unit when the misprint is detected.

8. The image forming apparatus of claim 1, further comprising an ejecting unit for ejecting the recording medium on which the image is formed by the image forming unit based on the input image data,
wherein the first reading unit reads the second image of the recording medium in a conveying path from the image forming unit to the ejecting unit.

9. A misprint detection method in an image forming apparatus for forming an image based on an input image data on a recording medium on which a first image is previously formed, comprising:
storing image data relating to the first image in a storage unit;
forming an image on the recording medium on which the first image is previously formed based on input image data;
reading a second image on the recording medium on which the image is previously formed based on the input image data; and
comparing an image data obtained by superposing the input image data on the image data relating to the first image with an image data relating to the read second image to detect a misprint in the image forming unit.

10. The misprint detection method of claim 9, further comprising: reading the first image of the recording medium to obtain the image data relating to the first image.

11. The misprint detection method of claim 9, further comprising: ejecting the recording medium to an ejecting unit which is previously set as an ejection destination of the misprint among a plurality of ejecting units when the misprint is detected.

12. The misprint detection method of claim 9, further comprising: displaying a warning on an operation display unit when the misprint is detected.
